(19) United States
(12) Patent Application Publication
(10) Pub. No.: US 2024/0027021 A1
(43) Pub. Date: Jan. 25, 2024

(54) SURFACE MOUNTED ELECTRICAL DEVICE SUPPORT ASSEMBLIES

(71) Applicant: Hubbell Incorporated, Shelton, CT (US)

(72) Inventors: Victor Beristany, South Bend, IN (US); Krzysztof Wojciech Korcz, Granger, IN (US)

(73) Assignee: Hubbell Incorporated, Shelton, CT (US)

(21) Appl. No.: 18/354,141

(22) Filed: Jul. 18, 2023

Related U.S. Application Data
(60) Provisional application No. 63/369,081, filed on Jul. 22, 2022.

(51) Int. Cl. F16M 13/02

(52) U.S. Cl. CPC F16M 13/027

(57) ABSTRACT

The electrical device support assembly for securement to a surface is provided. The assembly includes a support bracket having an outer rim, a main region, an inner region, and one or more first apertures configured to secure the support bracket to a pair of structural supports. The outer rim surrounds the main region. The main region surrounding the inner region. The inner region includes one or more second apertures that are configured for mechanical connection of an electrical device to the support bracket.

### CROSS REFERENCE TO RELATED APPLICATIONS

This application claims benefit of U.S. Provisional Application 63/369,081 filed Jul. 22, 2022, the entire contents of which are incorporated herein by reference.

### BACKGROUND

### 1. Field of the Invention

The present disclosure is related to supports for electrical devices. More particularly, the present disclosure is related to surface mounted electrical device support assemblies.

### 2. Description of Related Art

Electrical junction boxes are typically installed in walls and ceilings. Electrical conductors can be run from the service panel through the walls and/or ceilings so as to terminate in a junction box. An electrical device—such as but not limited to an outlet, a light, a fan, another others—can be operatively coupled with the electrical conductor in the junction box in a known manner.

When installed in a ceiling, the junction box can be exposed to differing levels of forces imparted by the electrical device.

Some ceiling junction boxes are configured for support of electrical devices—such as but not limited to flush mount or semi-flush mount lights—that generally impart only a vertical load and/or static load to the junction box—namely impart only light-duty forces to the junction box. These junction boxes are often secured to only one ceiling joist. For ease of discussion, this type of junction box is referred to herein as “light-duty”.

Other ceiling junction boxes are configured for support of electrical devices imparting heavier vertical loads and/or imparting dynamic forces such as rotational forces to the junction box. For example, these junction boxes can be operatively connected to electrical devices such as, but not limited to, ceiling fans, combined fan/lighting devices, high weight chandeliers, and other high load imparting devices. These junction boxes are often secured to two adjoining ceiling joists. For ease of discussion, this type of junction box is referred to herein as “heavy-duty”.

The light-duty ceiling junction boxes are typically more expensive to purchase and install then the heavy-duty ceiling junction boxes. Thus, it is common for builders to minimize construction costs by installing only the less expensive light-duty ceiling junction boxes—in combination with an electrical device that imparts light-duty forces.

After installation, namely once covered with drywall, it can be difficult to determine whether the junction box is light-duty or heavy-duty.

Homeowners looking to upgrade from the builder installed light-duty electrical device to a heavier electrical device such as a chandelier and/or to a ceiling fan are presented with the challenge of either installing a heavy-duty device onto a light-duty junction box—or tearing out the drywall to replace/inspect the junction box to determine its rating.

Recently, it has been proposed to provide mount the support for such heavy-duty electrical devices onto the surface of the ceiling such as that disclosed in Applicant's own U.S. Pat. No. 7,271,350.

However, it has been determined by the present disclosure that there is a need for improved surface mounted electrical device supports that overcome and/or alleviate one or more of the deficiencies and deleterious effects of the prior art junction boxes and/or supports.

### SUMMARY

An electrical device support assembly for securement to a surface is provided. The assembly includes a support bracket having an outer rim, a main region, an inner region, and one or more first apertures configured to secure the support bracket to a pair of structural supports of the surface. The outer rim surrounds the main region and the main region surrounds the inner region. The inner region includes one or more second apertures that are configured for mechanical connection of an electrical device to the support bracket.

In some embodiments either alone or together with any one or more of the aforementioned and/or after-mentioned embodiments, the one or more first apertures are in the outer rim or the main region.

In some embodiments either alone or together with any one or more of the aforementioned and/or after-mentioned embodiments, the inner region has a first window through which electrical leads of an electrical device can pass.

In some embodiments either alone or together with any one or more of the aforementioned and/or after-mentioned embodiments, the main region includes a plurality of first windows through which electrical leads of an electrical device can pass.

In some embodiments either alone or together with any one or more of the aforementioned and/or after-mentioned embodiments, the plurality of first windows are a plurality of knockouts.

In some embodiments either alone or together with any one or more of the aforementioned and/or after-mentioned embodiments, the outer rim is offset from the main region by a first distance along an axis and the main region is offset from the inner region by a second distance along the axis.

In some embodiments either alone or together with any one or more of the aforementioned and/or after-mentioned embodiments, the first distance provides a space through which the electrical leads can pass.

In some embodiments either alone or together with any one or more of the aforementioned and/or after-mentioned embodiments, the assembly further includes a cover plate positioned on the outer rim so that an enclosed space is defined in the support bracket.

In some embodiments either alone or together with any one or more of the aforementioned and/or after-mentioned embodiments, the cover is between the surface and the support bracket or the bracket is between the surface and the cover.

In some embodiments either alone or together with any one or more of the aforementioned and/or after-mentioned embodiments, the first apertures have a center-to-center distance equal to a center-to-center distance (D) of the pair of structural supports.

In some embodiments either alone or together with any one or more of the aforementioned and/or after-mentioned embodiments, the support bracket is configured such that the outer rim extends into the main area to define ears on opposite sides of a portion of the outer rim having the at least one first apertures.

In some embodiments either alone or together with any one or more of the aforementioned and/or after-mentioned embodiments, the support bracket is formed as a single piece of galvanized steel.

In some embodiments either alone or together with any one or more of the aforementioned and/or after-mentioned embodiments, the assembly further includes a decorative cover. The decorative cover is sized to conceal the support bracket and has second window sized and positioned to be in alignment with the inner region of the support bracket when the cover is removably connected to the support bracket.

In some embodiments either alone or together with any one or more of the aforementioned and/or after-mentioned embodiments, the decorative cover has an integrally formed connector that is removably connectable with the support bracket.

An electrical device support assembly for securement to a surface is provided. The assembly includes a support bracket having an outer rim, a main region, and an inner region, the outer rim surrounding the main region, and the main region surrounding the inner region. First apertures are in the main region and are configured to secure the support bracket to a pair of structural supports of the surface. The first apertures have a center-to-center distance equal to a center-to-center distance (D) of the pair of structural supports. A first distance offsets the outer rim from the main region in a first direction. Two second apertures in the main region are configured for mechanical connection of an electrical device to the support bracket. A ground terminal in the main region is configured for grounding connection of the electrical device. A cover plate on the outer rim defines an enclosed space in the support bracket. The enclosed space is defined by the first distance and is between the main region of the bracket, which is against the surface, and the cover. A plurality of knockouts are in the main region through which electrical leads of an electrical device can pass.

In some embodiments either alone or together with any one or more of the aforementioned and/or after-mentioned embodiments, the support bracket includes a second distance that offsets the inner region from the main region in the first direction.

In some embodiments either alone or together with any one or more of the aforementioned and/or after-mentioned embodiments, the support bracket is formed as a single piece of galvanized steel.

In some embodiments either alone or together with any one or more of the aforementioned and/or after-mentioned embodiments, the main region is an x-shaped structure with the ground terminal and the at least two second apertures on alternating legs of the x-shaped structure.

In some embodiments either alone or together with any one or more of the aforementioned and/or after-mentioned embodiments, the assembly further includes a decorative cover. The decorative cover is sized to conceal the support bracket and has second window sized and positioned to be in alignment with the inner region of the support bracket when the cover is removably connected to the support bracket.

In some embodiments either alone or together with any one or more of the aforementioned and/or after-mentioned embodiments, the decorative cover has an integrally formed lip that is removably connectable with the outer rim of the support bracket.

The above-described and other features and advantages of the present disclosure will be appreciated and understood by those skilled in the art from the following detailed description, drawings, and appended claims.

### DESCRIPTION OF THE DRAWINGS

FIG. 1 is an exploded view of an exemplary embodiment of a surface mount support assembly according to the present disclosure in a first use position;

FIG. 2 is a bottom perspective view of an exemplary embodiment of a support bracket of the assembly of FIG. 1;

FIG. 3 is a top perspective view of the support bracket of FIG. 2;

FIG. 4 is a sectional view of the support bracket of FIG. 2 taken along line 4-4 in FIG. 3;

FIG. 5 is a sectional view of the support bracket of FIG. 2 taken along line 5-5 in FIG. 3;

FIG. 6 is a bottom perspective view of the support bracket of FIG. 2 in relation to a fan mount cover;

FIG. 7 is a partial exploded view of the assembly of FIG. 1 in a second use position;

FIG. 8 is a bottom perspective view of an exemplary embodiment of a decorative cover of the assembly of FIG. 1;

FIG. 9 is an enlarged view of an exemplary embodiment of a connector of the decorative cover of FIG. 8;

FIG. 10 is an exploded view of an alternate exemplary embodiment of a surface mount support assembly according to the present disclosure;

FIG. 11 is a partial exploded view of the assembly of FIG. 10;

FIG. 12 is a bottom perspective view of a support bracket of FIG. 10 in relation to a fan mount cover;

FIG. 13 is a side view of the support bracket of FIG. 12;

FIG. 14 is a top perspective view of the support bracket of FIG. 12;

FIG. 15 is a bottom perspective view of an exemplary embodiment of a decorative cover of the assembly of FIG. 10;

FIG. 16 is a bottom perspective view of another exemplary embodiment of a support bracket for use in the assembly of FIG. 10;

FIG. 17 is an exploded view of another exemplary embodiment of a surface mount support assembly according to the present disclosure;

FIG. 18 is a bottom perspective view of a support bracket of FIG. 17;

FIG. 19 is a top perspective view of the support bracket of FIG. 17;

FIG. 20 is a partial exploded view of the assembly of FIG. 17

FIG. 21 is a bottom perspective view of an exemplary embodiment of a decorative cover of the assembly of FIG. 17; and

FIG. 22 is a sectional view of an edge region of the decorative cover of FIG. 21.

### DETAILED DESCRIPTION

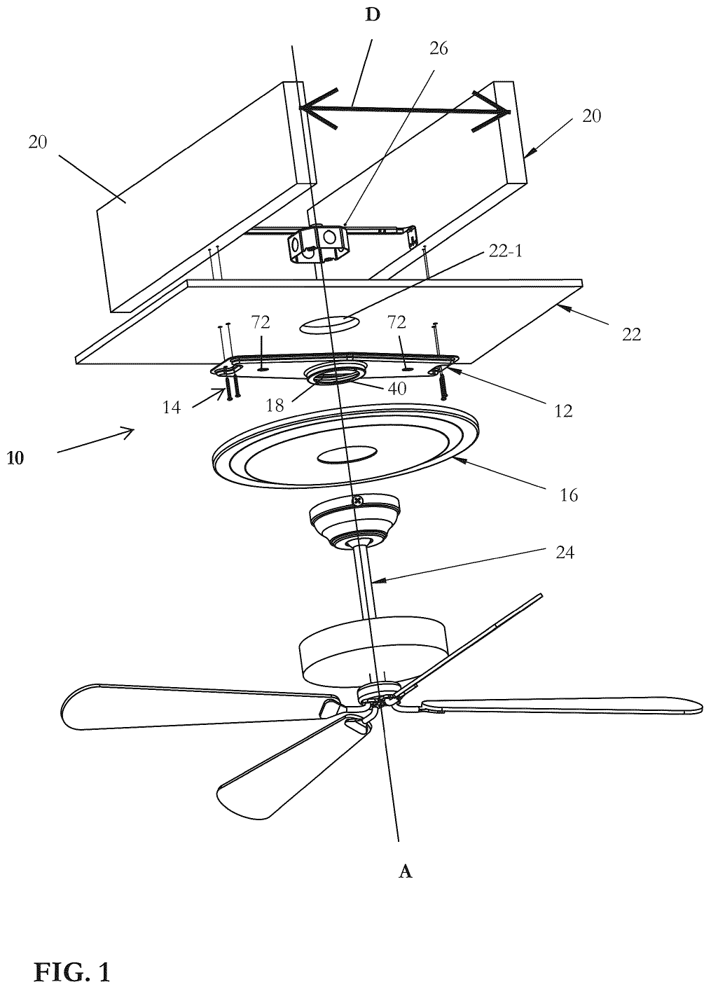

Referring to the drawings and in particular to FIG. 1, an exemplary embodiment of a surface mount support assembly according to the present disclosure is shown and is generally referred to by reference numeral 10.

Assembly 10 includes a support bracket 12 and, in some embodiments, one or more fasteners 14, a decorative cover 16 and/or one or more ground terminals 18. Assembly 10 is configured such that support bracket 12 can be mounted by fasteners 14 to two structural supports 20 against a surface 22 so as to allow connection between an electrical device 24 and a junction box 26.

Advantageously, assembly 10 can be used to install heavy-duty electrical devices 24 without removal or replacement of light-duty box 26 and without damage to surface 22. Rather, assembly 10 provides for mechanical connection of electrical device 24 that has heavy-duty requirements to supports 20 to enable electrical connection of the electrical device to junction box 26 of a light-duty rating.

In the illustrated embodiment, supports 20 are ceiling joists and surface 22 is ceiling drywall, while electrical device 24 is a fan, and junction box 26 is a light-duty rated box. Of course, it is contemplated by the present disclosure for assembly 10 to find use with other supports 20, surfaces 22, electrical devices 24, and junction boxes 26.

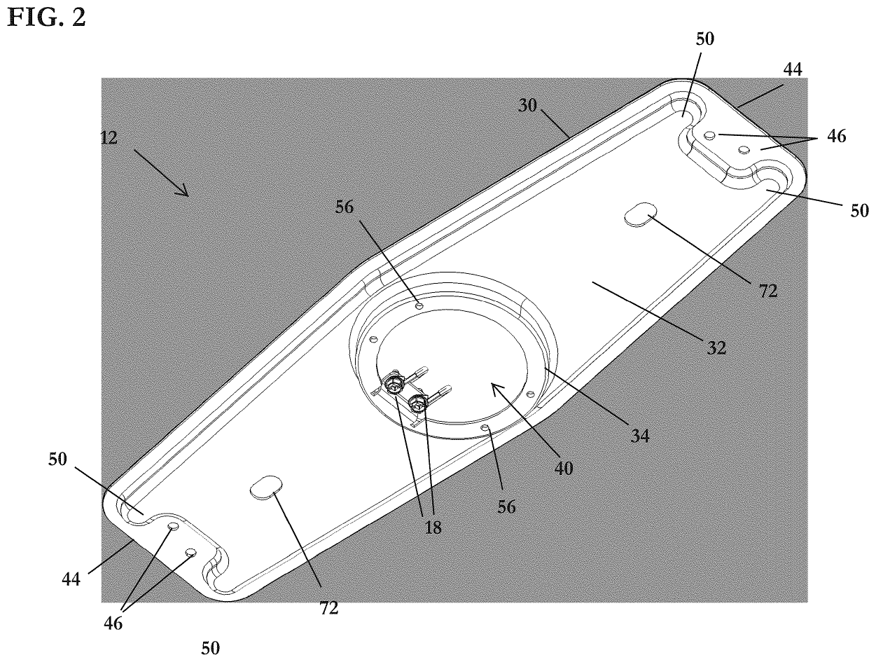

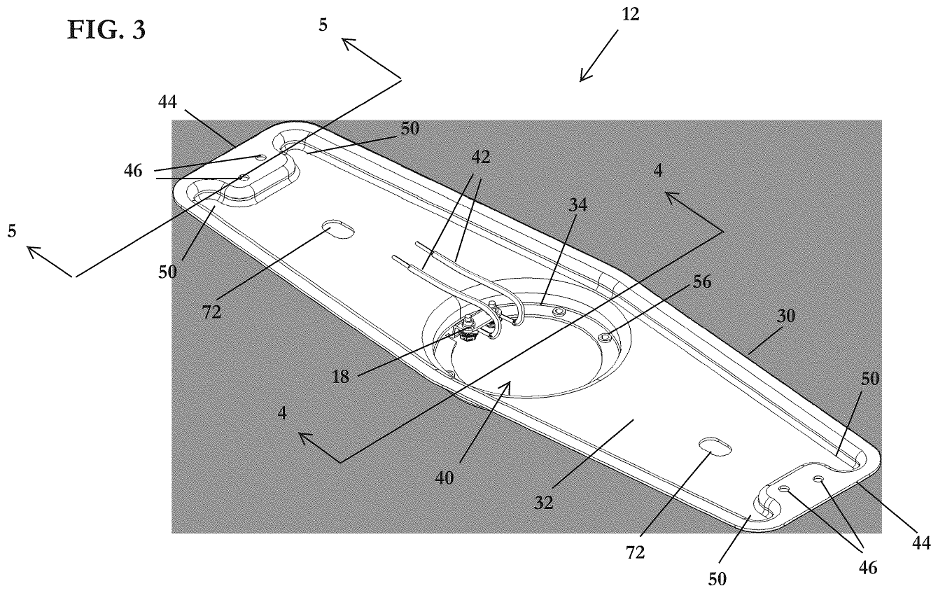

Support bracket 12 is described in detail with simultaneous reference to FIGS. 2-6. Bracket 12 has an outer rim 30, a main region 32, and an inner region 34.

Outer rim 30 surrounds the main region 32 and is offset from the main region by a first distance 36 along axis A. Main region 32 surrounds inner region 34 and is offset from the inner rim by a second distance 38 along axis A. Inner region 34 includes a first window 40 through which electrical leads 42 of electrical device 24 can pass.

Outer rim 30 includes ends 44 having first apertures 46 configured to receive fasteners 14 to secure bracket 12 to supports 20. In the illustrated embodiment, ends 44 each include two first apertures 46 so that bracket 12 is secured to support 20 by four fasteners 14. Of course, it is contemplated by the present disclosure for assembly 10 to have any desired number of fasteners 14 and first apertures 46.

Supports 20 are typically installed a predetermined center-to-center distance (D) away from one another. Common center-to-center distance (D) include 12 inches, 16 inches, 24 inches, and others. As such, assembly 10 can have any length sufficient for each for the center-to-center distance (D) of the supports 20 in which it is to be installed. Simply stated, first apertures 46 preferably have a center-to-center distance (D) selected from a group consisting of 12 inches, 16 inches, 24 inches, and others as needed.

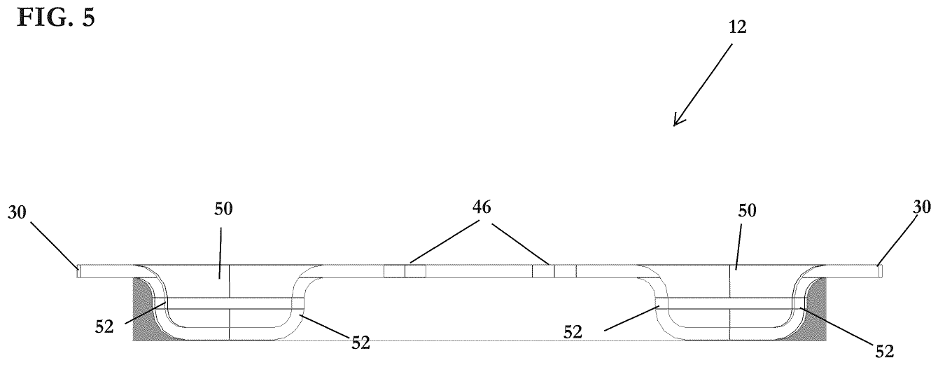

In some embodiments and as shown in FIG. 5, bracket 12 can be configured such that outer rim 30 extends into main area 32 to define ears 50 on opposite sides of the portion of the outer rim having first apertures 46. Ears 50 provide two wall segments 52 in outer rim 30 exterior to apertures 46. Without wishing to be bound by any particular theory, wall segments 52 are believed to provide outer rim 30 with an increased resistance to bending in the areas of first apertures 46.

In some embodiments, bracket 12 can include one or more ground terminals 18 for grounding of bracket 12, electrical device 24, and electrical leads 42 in a known manner. In the illustrated embodiment, terminals 18 are shown by way of example on inner region 34. Of course, it is contemplated by the present disclosure for terminals 18 to be formed on any portion of bracket 12.

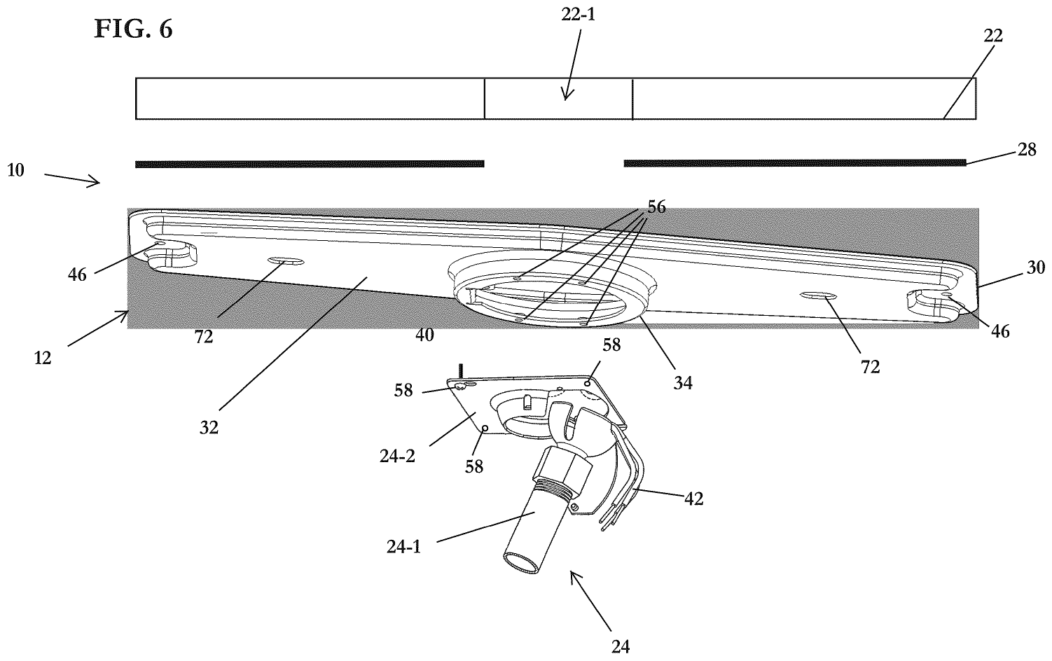

Inner region 34 further includes second apertures 56, which are configured for connection with electrical device 24. An exemplary connection between a portion of electrical device 24, in the form of a fan support ball 24-1 having leads 42, and assembly 10 is shown with reference to FIG. 6. It is common to support the fan support ball end 24-1 in a receiver 24-2 as is known from Applicant's own U.S. Pat. No. 9,371,962. As shown in FIG. 6, receiver 24-2 can be secured to support bracket 12 at second apertures 56 of inner region 34 using one or more second fasteners 58.

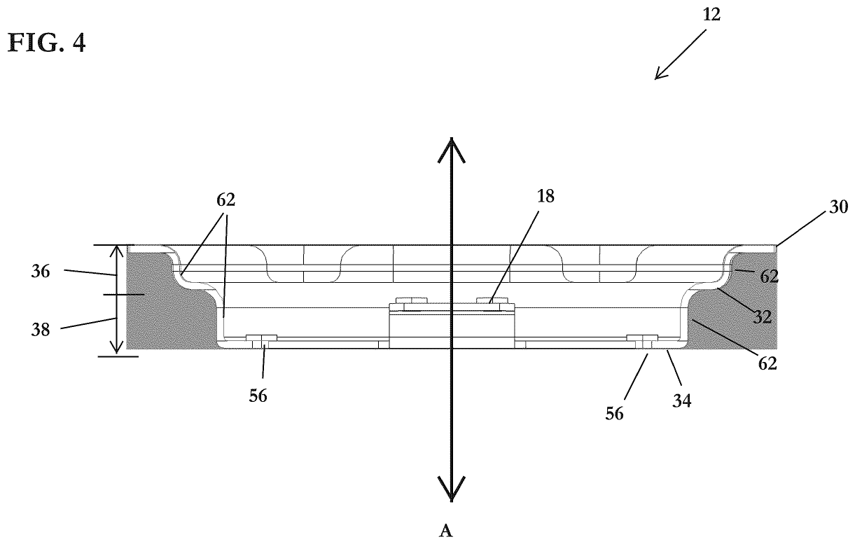

In some embodiments and as shown in FIG. 4, bracket 12 can be configured such that the portion of inner region 34 that has second apertures 56 is supported from outer rim 30 at each side by at least two wall segments 62. Without wishing to be bound by any particular theory, wall segments 62 are believed to provide inner region 34 with an increased resistance to bending in the areas of second apertures 56.

In some embodiments, bracket 12 is preferably formed as a single piece—but it is contemplated for bracket to be formed of multiple segments. Bracket 12 can be formed from any material having sufficient strength for the intended heavy-duty application. For example, bracket 12 can be formed of metal and/or polymer. Bracket 12 can be formed by molding, stamping, casting, drawing, and other known processes. In one particular example, bracket 12 is formed of a single piece of galvanized steel that is stamped, drawn, or molded into shape.

In some instances as shown in FIG. 1, junction box 26 is positioned between supports 20 such that surface 22 has opening 22-1 that is concentric along axis A with first window 40 of support bracket 12. The concentric alignment of opening 22-1 and first window 40 allows for electrical connection from device 24 into junction box 26 in a normal or common manner.

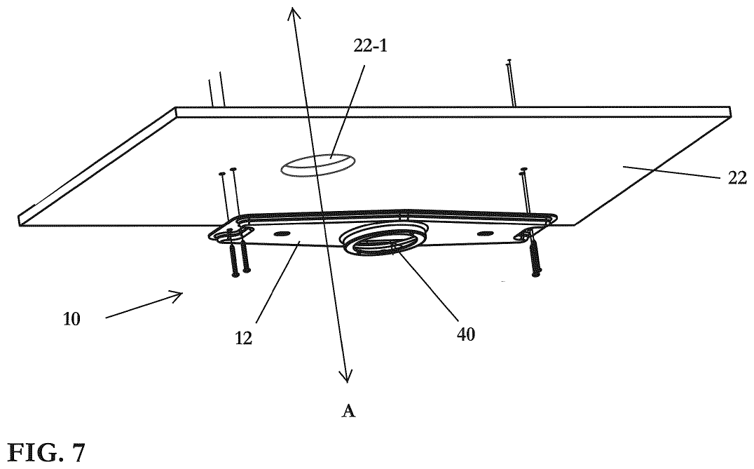

However, it is contemplated by the present disclosure for assembly 10 to find equal use with other installations such as that shown in FIG. 7. Here, surface 22 has an opening 22-2 that is offset along axis A with respect to window 40 of support bracket 12. As discussed above with respect to FIGS. 4 and 5, bracket 12 includes first distance 36 between outer rim 30 and main region 32—as well as second distance 38 between the main region and inner region 34. Thus and in this manner bracket 12 provides a space between main region 32 and surface 22 through which electrical leads 42 of electrical device 24 can—once extended through window 40—pass within the bracket to opening 22-2 and, thus, to junction box 26.

In some embodiments, assembly 10 can include be configured with a cover plate 28 that is positionable between surface 22 and bracket 12. When present, cover plate 28 covers surface 22 so that electrical leads 42 pass between bracket 12 and the plate without contacting the surface as shown in FIG. 6. Cover plate 28 can include one or more knockouts (not shown) to allow the user to select a position for an opening 28-1 that aligns with opening 22-1. Cover plate 28 can be secured to surface 22 in any desired manner.

Accordingly, assembly 10 is configured to pass electrical leads 42 from device 24, through window 40 and either through opening 22-1 (when the opening is aligned with the window) or through opening 22-2 then between main region 32 and surface 22 to opening 22-2 (when the opening is not aligned with the window). From either opening 22-1, 22-2, electrical leads 42 can be electrically connected with line and load conductors in junction box 26. Simply stated, assembly 10 is configured to allow for electrical connection between device 24 and junction box 26, while providing mechanical connection to supports 20.

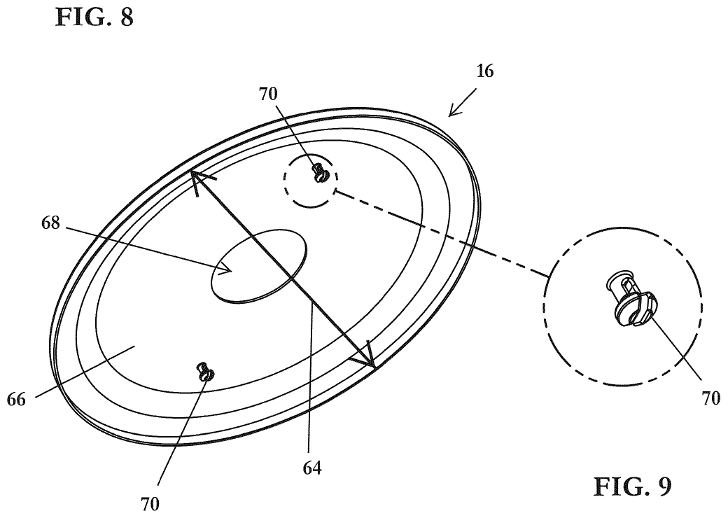

In some embodiments, assembly 10 can further include decorative cover 16 that conceals or otherwise provides a decorative appearance to the assembly. Cover 16 is described with reference to FIGS. 1, 8, and 9. Cover 16 can be in the form of a decorative medallion that is known in the art.

Cover 16 is removably connectable to bracket 12 and is sized and configured to conceal support bracket 12, when connected, with the exception of portions that are connectable to and shielded by electrical device 24.

Cover 16 has an outer perimeter 64, an inner cavity 66, a second window 68, and one or more connectors 70.

Outer perimeter 64 is larger than an outer dimension of bracket 12. Cavity 66 has sufficient volume to receive bracket 12 therein.

Second window 68 is sized so that, when cover 16 is removably connected to bracket 12, inner region 34 of the bracket extends into the cover at the second window—and in some embodiments past an outer surface of the cover.

Connectors 70 are removably connectable to corresponding connectors 72 defined on bracket 12. In the illustrated embodiment, connectors 70 are shown as pushpins and connectors 72 are shown as third apertures. Of course, it is contemplated by the present disclosure for cover 16 to be removably connected to bracket 12 in any desired manner.

When installed, cover 16 can conceal bracket 12 such that a bottom edge 74 of the cover is in contact with surface 22. In some embodiments, connectors 70, 72 can provide a biasing force to maintain edge 74 in contact with surface.

For example, cover 16 can be formed of metal and/or polymer. Cover 16 can be formed by molding, stamping, casting, drawing, and other known processes. In one particular example, cover 16 is formed of a single piece of molded insulating material such as, but not limited to, plastic, polyurethane, and other materials.

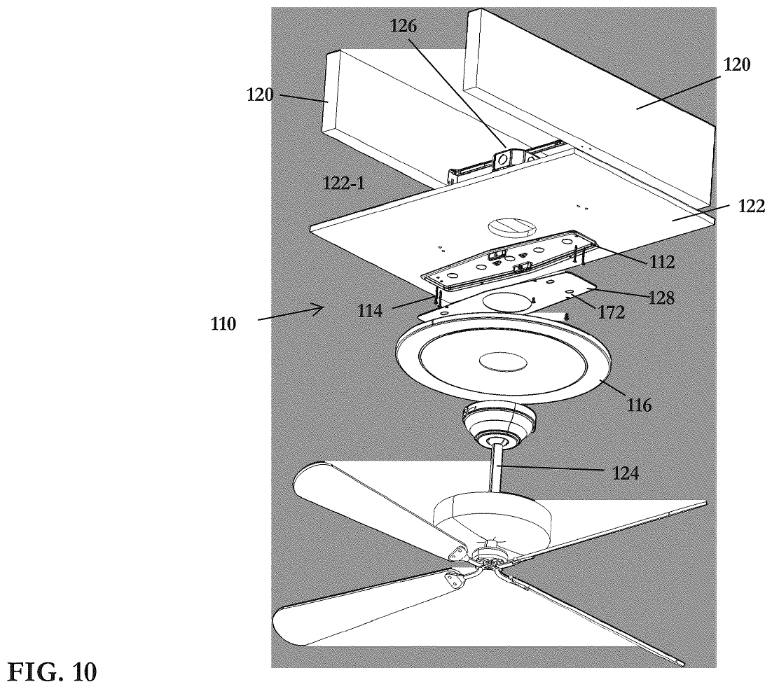

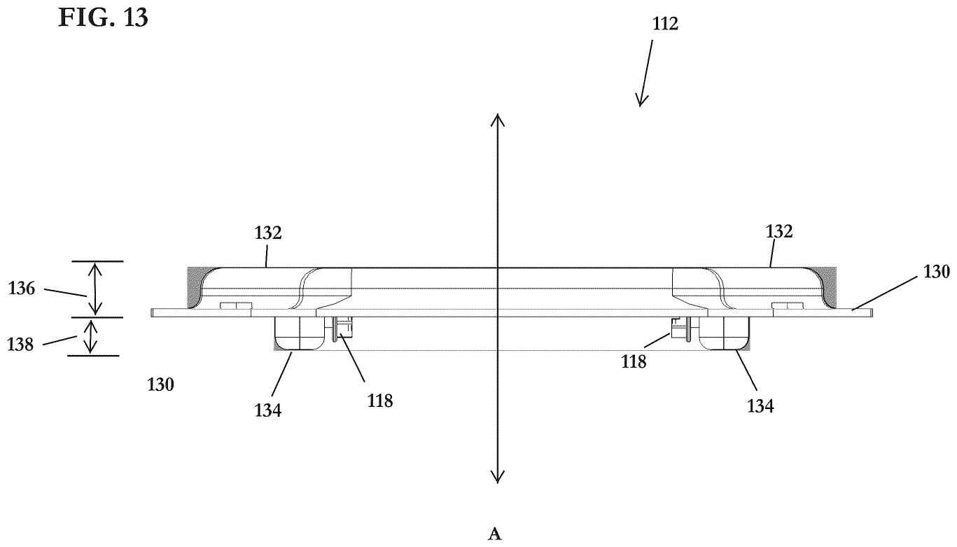

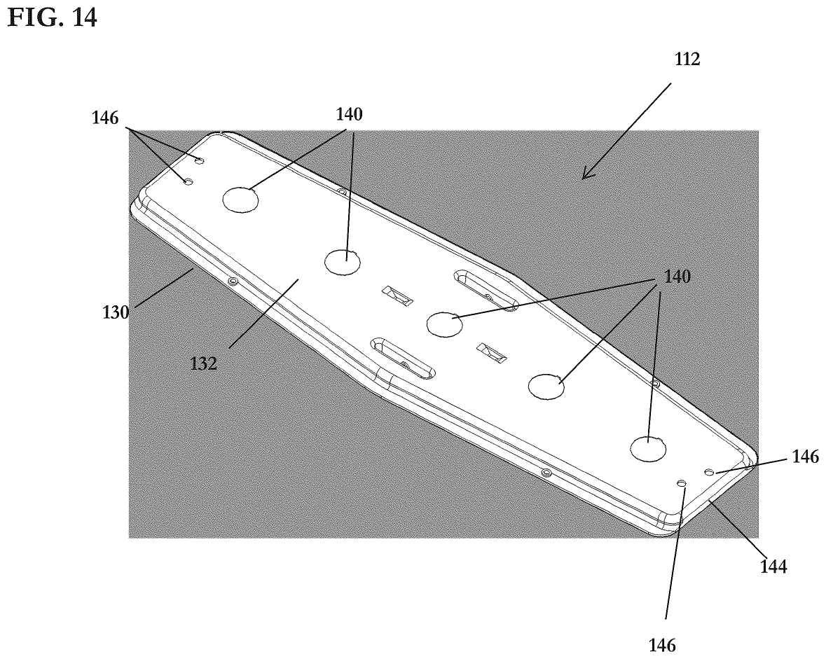

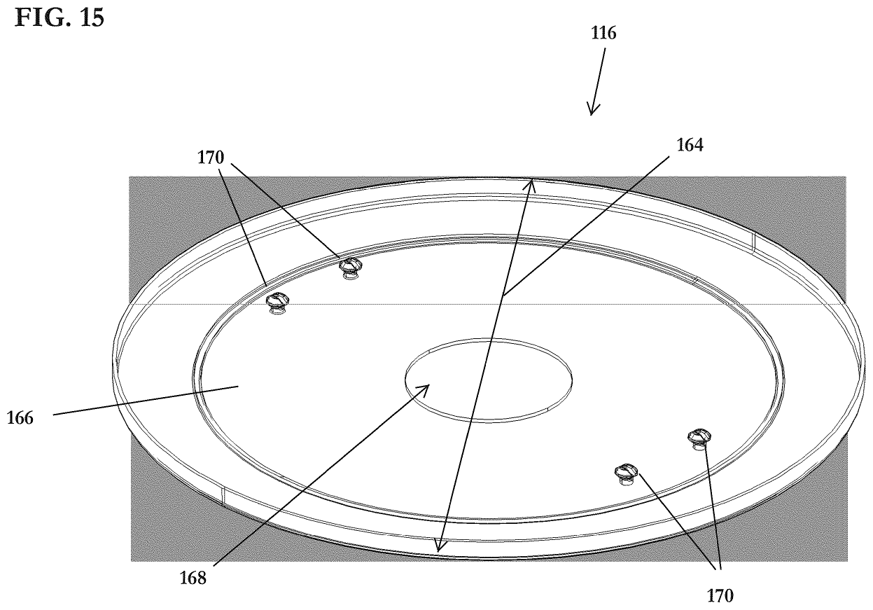

Referring now to FIGS. 10-15 an alternate exemplary embodiment of a surface mount support assembly according to the present disclosure is shown and is generally referred to by reference numeral 110.

Assembly 110 includes a support bracket 112 and, in some embodiments, one or more fasteners 114, a decorative cover 116 and/or one or more ground terminals 18. Assembly 110 is configured such that support bracket 112 can be mounted by fasteners 114 to two structural supports 120 against a surface 122 so as to allow connection between an electrical device 124 and a junction box 126. Thus, assembly 110 is configured to allow for electrical connection between device 124 and junction box 126, while providing mechanical connection to supports 120.

Advantageously, assembly 110 can be used to install heavy-duty electrical devices 124 without removal or replacement of light-duty box 126 and without damage to surface 122. Rather, assembly 110 provides for mechanical connection of electrical device 124 that has heavy-duty requirements to supports 120 to enable electrical connection of the electrical device to junction box 126 of a light-duty rating.

In the illustrated embodiment, supports 120 are ceiling joists and surface 122 is ceiling drywall, while electrical device 124 is a fan, and junction box 126 is a light-duty rated box. Of course, it is contemplated by the present disclosure for assembly 110 to find use with other supports 120, surfaces 122, electrical devices 124, and junction boxes 126.

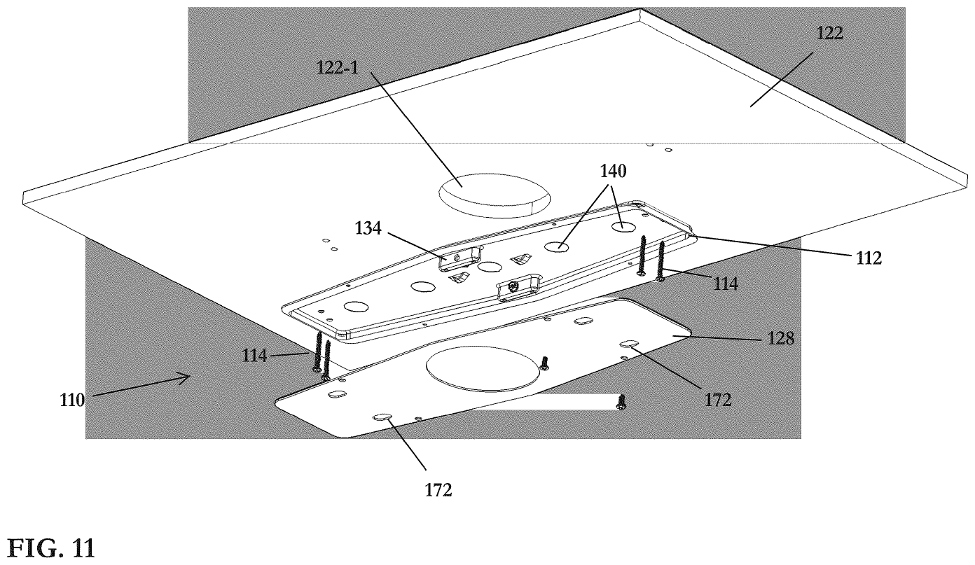

Support bracket 112 is described in detail with simultaneous reference to FIGS. 11-15.

Bracket 112 has an outer rim 130, a main region 132, and one or more inner rims 134 (two shown).

Outer rim 130 surrounds the main region 132 and is offset from the main region by a first distance 136 along axis A. Inner rims 134 are surrounded by main region 132 and are offset from the main region by a second distance 138 along axis A.

Main region 132 includes a plurality of windows 140 sized and positioned to overlap, at least partially, with an opening 122-1 in the surface 122. In the illustrated embodiment, windows 140 are configured in the form of knockouts. Thus, the user can modify bracket 112 by removing the knockout from one of windows 140 to form passageway for electrical leads 142 of electrical device 124 to pass to junction box 126—where the window at least partially overlaps the opening 122-1.

Outer rim 130 includes ends 144 having first apertures 146 configured to receive fasteners 114 to secure bracket 112 to supports 120. In the illustrated embodiment, ends 144 each include two first apertures 146 so that bracket 112 is secured to support 120 by four fasteners 114. Of course, it is contemplated by the present disclosure for assembly 110 to have any desired number of fasteners 114 and first apertures 146.

Assembly 110 can have any length sufficient for each for the center-to-center distance (D) of the supports 120 in which it is to be installed. Simply stated, first apertures 146 preferably have a center-to-center distance (D) selected from a group consisting of 12 inches, 16 inches, 24 inches, and others as needed.

In some embodiments, bracket 112 can include one or more ground terminals 118 for grounding of bracket 112, electrical device 124, and electrical leads 142 in a known manner. In the illustrated embodiment, terminals 118 are shown by way of example on inner rims 134. Of course, it is contemplated by the present disclosure for terminals 118 to be formed on any portion of bracket 112.

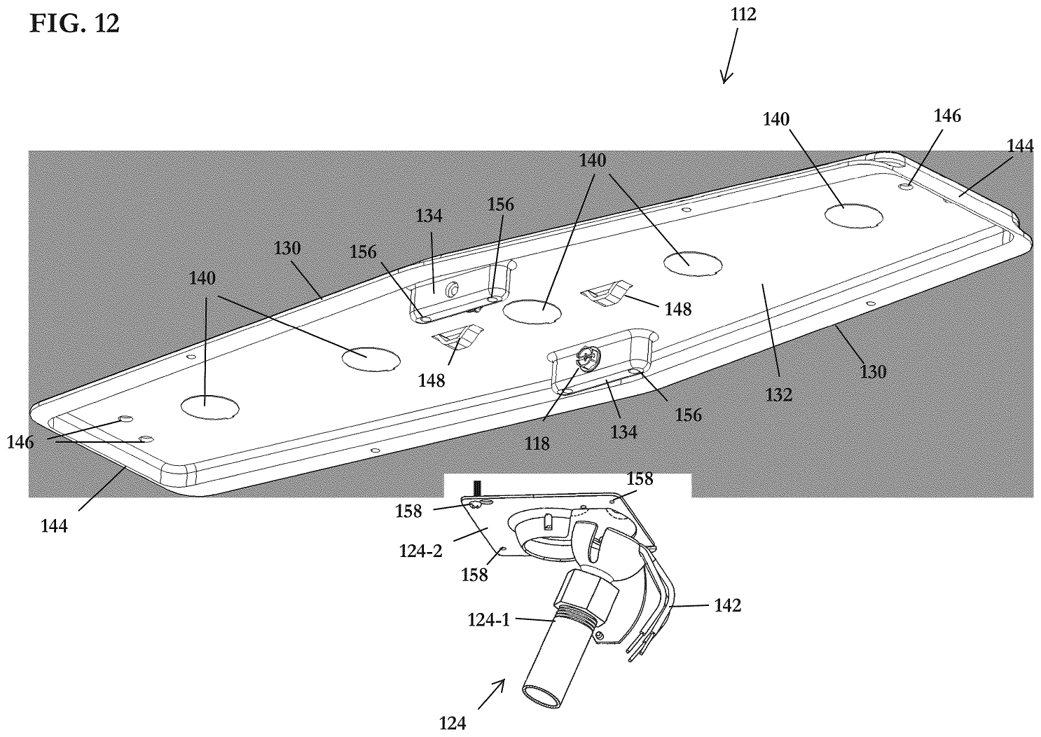

Inner rims 134 are configured for securing electrical device 124 to bracket 112. In some embodiments, inner rims 134 further include second apertures 156, which are configured for connection with electrical device 124. An exemplary connection between a portion of electrical device 124, in the form of a fan support ball 124-1 having leads 142, and assembly 110 is shown with reference to FIG. 12.

It is common to support the fan support ball end 124-1 in a receiver 124-2 as is known from Applicant's own U.S. Pat. No. 9,371,962. As shown in FIG. 12, receiver 124-2 can be secured to support bracket 112 at second apertures 156 of inner rims 134 using one or more second fasteners 158.

In some embodiments, bracket 112 is preferably formed as a single piece—but it is contemplated for bracket to be formed of multiple segments. Bracket 112 can be formed from any material having sufficient strength for the intended heavy-duty application. For example, bracket 12 can be formed of metal and/or polymer. Bracket 112 can be formed by molding, stamping, casting, drawing, and other known processes. In one particular example, bracket 112 is formed of a single piece of galvanized steel that is stamped, drawn, or molded into shape.

Although not illustrated with respect to bracket 112, it is contemplated by the present disclosure for bracket 112 to be configured such that outer rim 130 extends into main region 132 to define ears on opposite sides of the portion of the outer rim having first apertures 146 in the manner described above with respect to bracket 12.

In some embodiments, bracket 112 can include one or more arms 148 configured to receive zip ties or other cable management devices for securing electrical leads 142.

In some embodiments, assembly 110 can further include decorative cover 116 that conceals or otherwise provides a decorative appearance to the assembly. Cover 116 is described with reference to FIG. 15. Cover 116 can be in the form of a decorative medallion that is known in the art. Cover 116 is removably connectable to bracket 112 and is sized and configured to conceal support bracket 112, when connected, with the exception of portions that are connectable to and shielded by electrical device 124.

Cover 116 has an outer perimeter 164, an inner cavity 166, a second window 168, and one or more connectors 170.

Outer perimeter 164 is larger than an outer dimension of bracket 112. Cavity 166 has sufficient volume to receive bracket 112 therein.

Second window 168 is sized so that, when cover 116 is removably connected to bracket 112, inner rims 134 of the bracket extend into the cover at the second window—and in some embodiments past an outer surface of the cover.

Connectors 170 are removably connectable to corresponding connectors (not shown) defined on bracket 112. In the illustrated embodiment, connectors 170 are shown as pushpins received in apertures of the bracket. Of course, it is contemplated by the present disclosure for cover 116 to be removably connected to bracket 112 in any desired manner.

Assembly 110 can, in some embodiments, include a cover plate 128 positioned on bracket 112—such as on outer rim 130. When decorative cover 116 is present, cover plate 128 is between bracket 112 and the cover. Plate 126 can be secured to bracket 112 so that the space between defined between cover plate 128 and main region 132 defines a conduit or junction box for passage of electrical leads 142 from electrical device 124 and junction box 126.

In embodiments having cover plate 128, connectors 170 of decorative cover 116 are removably connectable to corresponding connectors 172 defined on cover plate 128. In the illustrated embodiment, connectors 170 are shown as pushpins and connectors 172 are shown as third apertures.

When installed, cover 116 can conceal bracket 112 such that a bottom edge 174 of the cover is in contact with surface 122. In some embodiments, connectors 170, 172 can provide a biasing force to maintain edge 174 in contact with surface.

Cover 116 can be formed of metal and/or polymer. Cover 116 can be formed by molding, stamping, casting, drawing, and other known processes. In one particular example, cover 116 is formed of a single piece of molded insulating material such as, but not limited to, plastic, polyurethane, and other materials.

Generally, bracket 112 is configured for installation to supports 120 in a position that is inverted with respect to that of bracket 12. Stated differently, bracket 12 is configured to form a space for running electrical leads 42 between the bracket and surface 22—and, in some embodiments—include cover plate 28 to prevent contact between the leads and the surface.

In contrast, bracket 112 is configured to form a space for running electrical leads 142 between the bracket and decorative cover 116—and, in some embodiments—include cover plate 128 to prevent contact between the leads and the decorative cover 116.

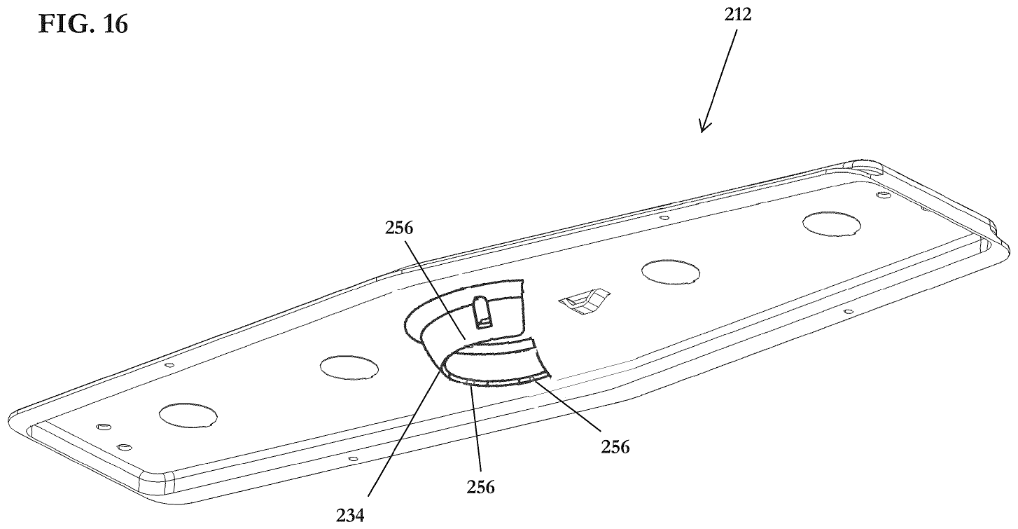

Referring now to FIG. 16 another alternate exemplary embodiment of a bracket 212 for use with the assembly 110.

Bracket 212 is specifically configured to support an electrical device in the form of a ceiling fan that has a fan support ball end. Here, bracket 212 includes inner rim 234 configured as a fan ball receiver that receives the ball end. In some embodiments, inner rim 234 can further include apertures 256 for securement of electrical devices other than a ceiling fan.

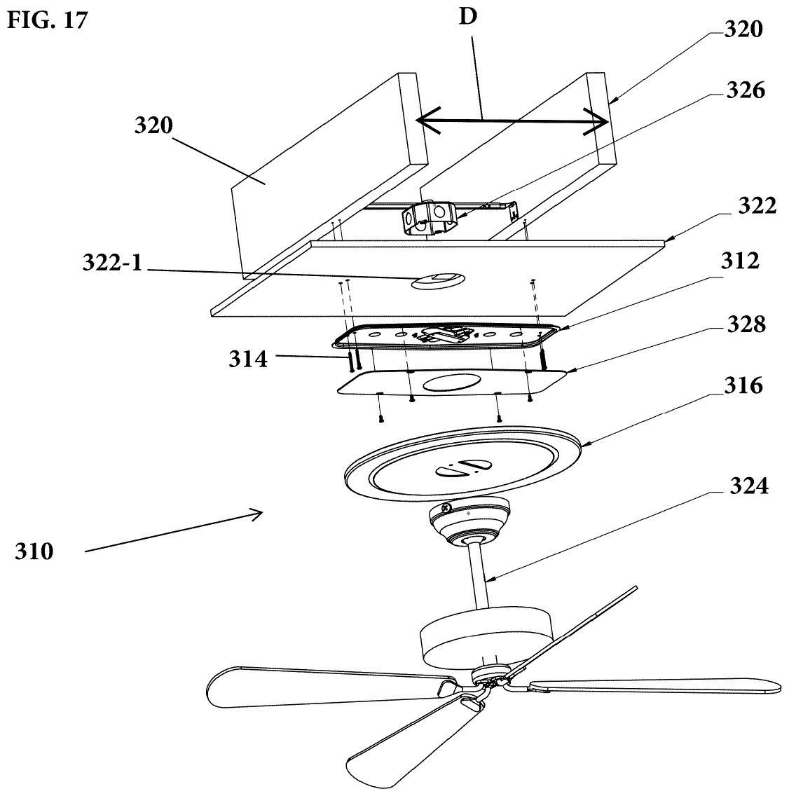

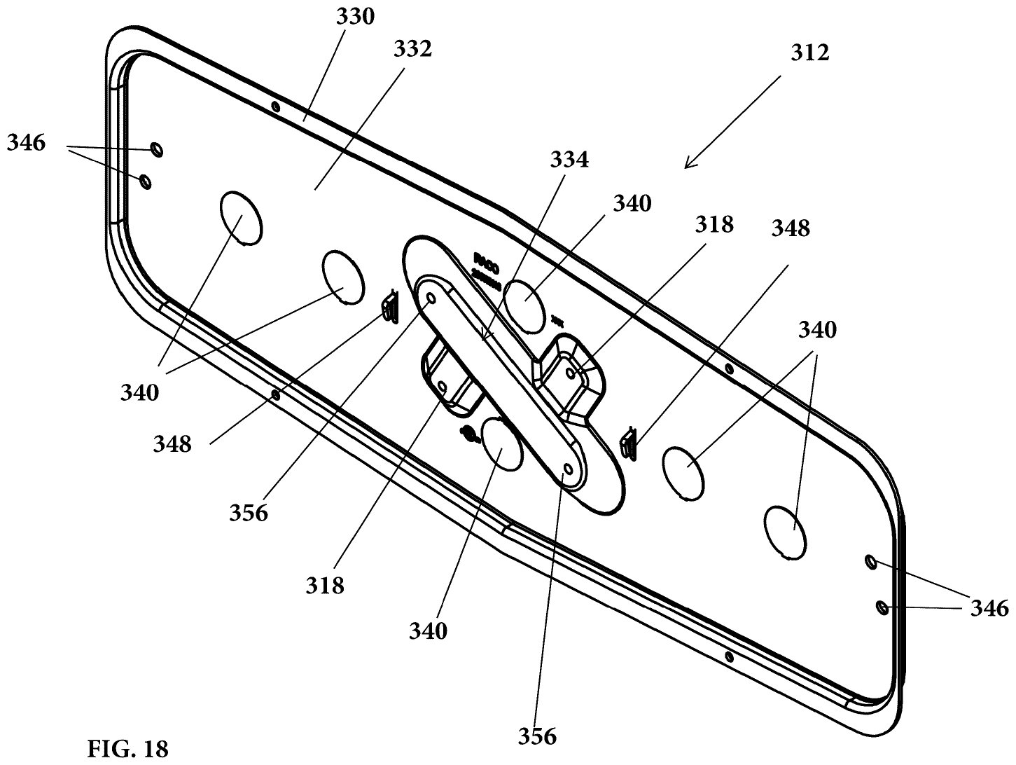

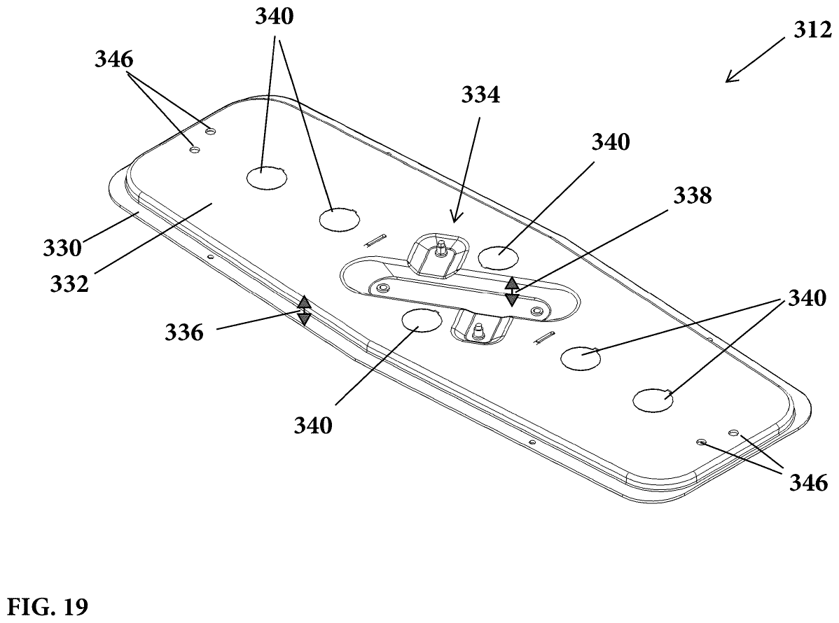

Referring now to FIGS. 17-22 another alternate exemplary embodiment of a surface mount support assembly according to the present disclosure is shown and is generally referred to by reference numeral 310.

Assembly 310 includes a support bracket 312 and, in some embodiments, one or more fasteners 314, a decorative cover 316 and/or one or more ground terminals 318. Assembly 310 is configured such that support bracket 312 can be mounted by fasteners 314 to two structural supports 320 against a surface 322 to allow connection between an electrical device 324 and a junction box 326. Thus, assembly 310 is configured to allow for electrical connection between device 324 and junction box 326, while providing mechanical connection to supports 320.

Advantageously, assembly 310 can be used to install heavy-duty electrical devices 324 without removal or replacement of light-duty box 326 and without damage to surface 322. Rather, assembly 310 provides for mechanical connection of electrical device 324 that has heavy-duty requirements to supports 320 to enable electrical connection of the electrical device to junction box 326 of a light-duty rating.

In the illustrated embodiment, supports 320 are ceiling joists and surface 322 is ceiling drywall, while electrical device 324 is a fan, and junction box 326 is a light-duty rated box. Of course, it is contemplated by the present disclosure for assembly 310 to find use with other supports 320, surfaces 322, electrical devices 324, and junction boxes 326.

Bracket 312 has an outer rim 330, a main region 332, and an inner region 334.

Outer rim 330 surrounds the main region 332 and is offset from the main region by a first distance 336 along axis A. Main region 332 surrounds inner region 334 and is offset from the inner region by a second distance 338 along axis A.

Main region 332 includes a plurality of windows 340 where the windows are sized and positioned so that at least one can overlap, at least partially, with an opening 322-1 in the surface 322. In the illustrated embodiment, windows 340 are configured in the form of knockouts. Thus, the user can modify bracket 312 by removing the knockout from one of windows 340 to form passageway for electrical leads (not shown) of electrical device 324 to pass to junction box 326—where the window at least partially overlaps the opening 322-1.

Main region 332 includes first apertures 346 configured to receive fasteners 314 to secure bracket 312 to supports 320. In the illustrated embodiment, each end of main region 332 includes two first apertures 346 so that bracket 312 is secured to support 320 by four fasteners 314. Of course, it is contemplated by the present disclosure for assembly 310 to have any desired number of fasteners 314 and first apertures 346.

Assembly 310 can have any length sufficient for each for the center-to-center distance (D) of the supports 320 in which it is to be installed. Simply stated, first apertures 346 preferably have a center-to-center distance (D) selected from a group consisting of 12 inches, 16 inches, 24 inches, and others as needed.

In some embodiments, bracket 312 can include one or more ground terminals 318 for grounding of the bracket, electrical device 324, and electrical leads (not shown) in a known manner. In the illustrated embodiment, terminals 318 are shown by way of example on inner region 334. Of course, it is contemplated by the present disclosure for terminals 318 to be formed on any portion of bracket 312.

Inner region 334 is configured for securing electrical device 324 to bracket 312. Here, inner region 334 further include second apertures 356, which are configured for connection with electrical device 324.

In the illustrated embodiment inner region 334 is configured as a generally x-shaped structure—with ground terminals 318 and second apertures 356 on alternating legs of the x-shaped structure. Without wishing to be bound by any particular theory, inner region 334 being raised by second distance 338 along axis A with respect to main region 332 combined with the x-shaped structure are believed to provide the inner region with an increased resistance to bending in the areas of second apertures 356. Of course, additional rigidity enhancing configurations for inner region 334 are contemplated by the present disclosure.

In some embodiments, bracket 312 is preferably formed as a single piece—but it is contemplated for bracket to be formed of multiple segments. Bracket 312 can be formed from any material having sufficient strength for the intended heavy-duty application. For example, bracket 312 can be formed of metal and/or polymer. Bracket 312 can be formed by molding, stamping, casting, drawing, and other known processes. In one particular example, bracket 312 is formed of a single piece of galvanized steel that is stamped, drawn, or molded into shape.

In some embodiments, bracket 312 can include one or more arms 348 configured to receive for securing electrical leads (not shown) of electrical device 324 as the leads pass from inner region 334 to window 340.

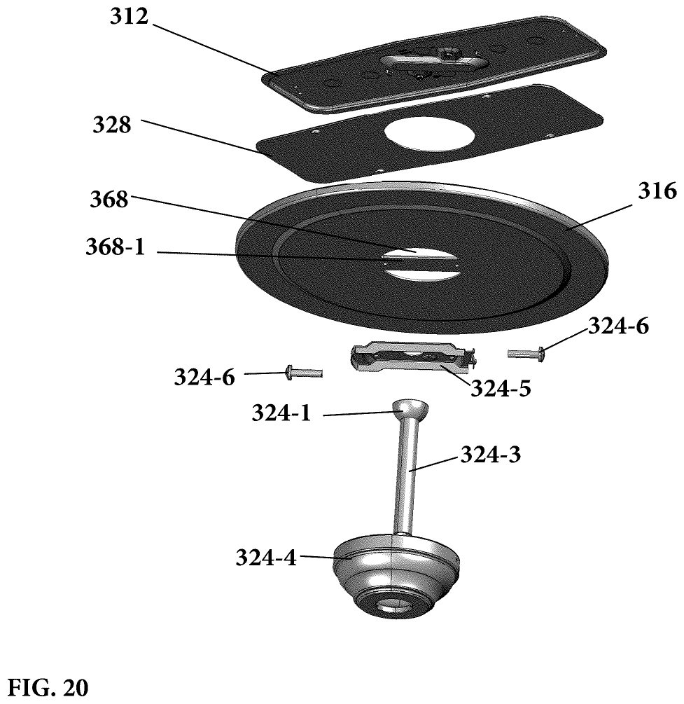

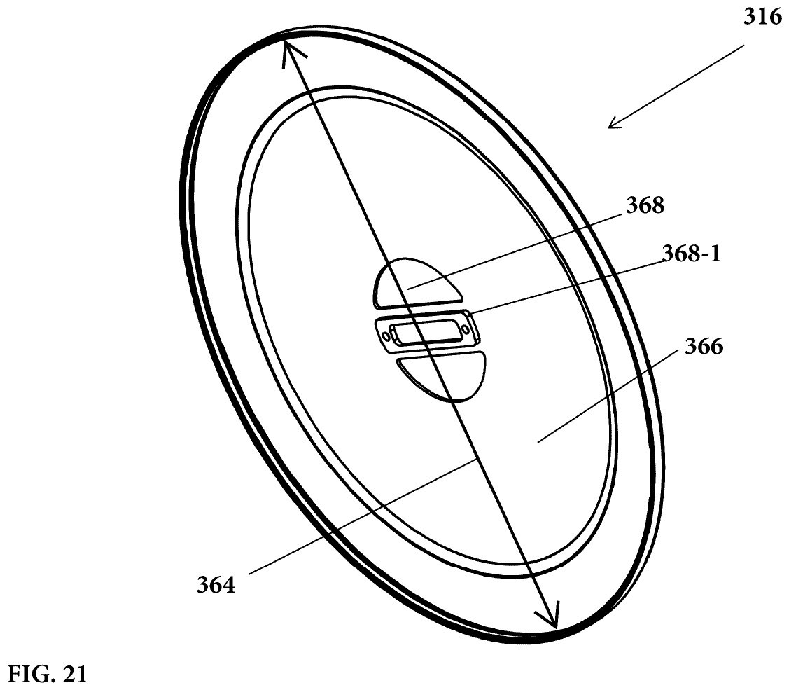

An exemplary connection between a portion of electrical device 324 and bracket 312 is shown with reference to FIG. 20, which illustrates electrical device 324 as a fan. Here, electrical device 324 has a fan support ball 324-1 depending from a fan rod 324-3, a ball cover 324-4, and a ball connector 324-5. During installation, connector 324-5 is first secured by fasteners (not shown) to inner region 334 at second apertures 356. Next, fan rod 324-2 is inserted through an opening in ball cover 324-4 so that the fan support ball 324-1 is retained in the cover. Finally, ball cover 324-4 is secured to connector 324-5 by way of fasteners 324-6.

It is known to support the fan support ball end 324-1 in a receiver (not shown) as is known from Applicant's own U.S. Pat. No. 9,371,962. Thus and in some embodiments, connector 324-5 can be a prior art receiver such that ball cover 324-4 is not a weight bearing member, but merely shields or covers the connection. It should be recognized that in this embodiment, connector 324-5 is separate from and connected to bracket 312 similar to that shown in FIG. 12. However, it is also contemplated for the receiver embodiment to eliminate connector 324-5 and form the receiver integral with inner region 334 similar to that shown in FIG. 16.

Assembly 310 can, in some embodiments, include a cover plate 328 positioned on the bracket 312—such as on outer rim 330. When decorative cover 316 is present, cover plate 328 is between bracket 312 and the decorative cover. Cover plate 328 can be secured to bracket 312 so that the space between defined between cover plate 328 and main region 332 defines a conduit or junction box for passage of electrical leads (not shown) from electrical device 324 to and through window 340 and into junction box 326.

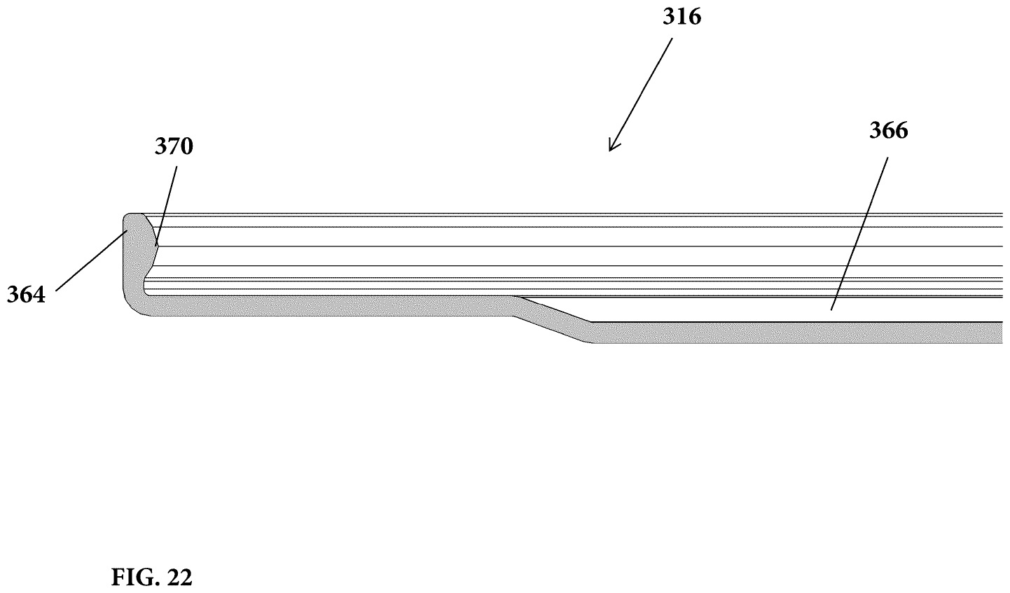

In some embodiments, assembly 310 can further include decorative cover 316 that conceals or otherwise provides a decorative appearance to the assembly. Cover 316 is described with reference to FIGS. 21-22.

Cover 316 can be formed of metal and/or polymer and can be formed by molding, stamping, casting, drawing, and other known processes. In one particular example, cover 316 is formed of a single piece of molded insulating material such as, but not limited to, plastic, polyurethane, and other materials.

Cover 316 can be in the form of a decorative medallion that is known in the art. Cover 316 is removably connectable to bracket 312 and is sized and configured to conceal support bracket 312, when connected, with the exception of portions that are connectable to and shielded by electrical device 324.

Cover 316 has an outer perimeter 364, an inner cavity 366, and a second window 368. Cover 316 has an inwardly facing connector or lip 370 at outer perimeter. Cavity 366 has sufficient volume receive bracket 312 therein.

Second window 368 is sized so that, when cover 316 is removably connected to bracket 312, inner region 334 of the bracket is in alignment with the second window and in some embodiments protrudes through the second window.

Lip 370 is removably connectable to outer rim 330 of bracket 312. Specifically, outer rim 330 defines a space between the outer rim and surface 322 sufficient to receive lip 370. When cover 316 is pressed onto bracket 312, the cover resiliently flexes to allow lip 370 to pass over outer rim 330 and flex back into shape with the lip resting in the space between the outer rim 330 and the surface 322.

Of course, it is contemplated by the present disclosure for cover 316 to be removably connected to bracket 312 in any desired manner. For example, cover 316 can further include a cross member 368-1 in window 368, where the cross member 368-1 can secure the cover to bracket 312. For example, when connector 324-4 is secured by fasteners (not shown) to inner region 334 at second apertures 356, the cross member 368-1 is sandwiched between the connector 324-1 and bracket 312 to hold cover 316 in position.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

PARTS LIST

| | |
|---|---|
| surface mount support assembly 10, 110, 310 | wall segments 62 |
| support bracket 12, 112, 212, 312 | outer perimeter 64, 164, 364 |
| one or more fasteners 14, 114, 314 | inner cavity 66, 166, 366 |
| decorative cover 16, 116, 316 | second window 68, 168, 368 |
| one or more ground terminals 18, 118, 318 | one or more connectors 70, 170, 370 |
| structural supports 20, 120, 320 | corresponding connectors 72, 172 |
| surface 22, 122, 322 | bottom edge 74, 174 |
| opening 22-1, 22-2, 122-1, 322-1 | arms 348 |
| electrical device 24, 124, 324 | fan rod 324-3 |
| fan support ball 24-1, 124-1, 324-1 | ball cover 324-4 |
| ball end receiver 24-2, 124-2 | connector 324-5 |
| junction box 26, 126, 326 | fastener 324-6 |
| cover plate 28, 128, 328 | cross member 368-1 |
| outer rim 30, 130, 330 | |
| main region 32, 132, 332 | |
| inner region 34, 134, 234, 334 | |
| first distance 36, 136, 336 | |
| axis A | |
| second distance 38, 138, 338 | |
| first window 40, 140, 340 | |
| electrical leads 42, 142 | |
| ends 44, 144 | |
| first apertures 46, 146, 346 | |
| center-to-center distance (D) | |
| ears 50 | |
| wall segments 52 | |
| second apertures 56, 156, 256, 356 | |
| second fasteners 58, 158 | |

What is claimed is:

1. An electrical device support assembly for securement to a surface, comprising:
a support bracket having an outer rim, a main region, an inner region, and one or more first apertures configured to secure the support bracket to a pair of structural supports of the surface,
the outer rim surrounding the main region,
the main region surrounding the inner region, and
the inner region includes one or more second apertures that are configured for mechanical connection of an electrical device to the support bracket.

2. The assembly of claim 1, wherein the one or more first apertures are in the outer rim or the main region.

3. The assembly of claim 1, wherein the inner region has a first window through which electrical leads of an electrical device can pass.

4. The assembly of claim 1, wherein the main region comprises a plurality of first windows through which electrical leads of an electrical device can pass.

5. The assembly of claim 4, wherein the plurality of first windows comprises a plurality of knockouts.

6. The assembly of claim 1, wherein the outer rim is offset from the main region by a first distance along an axis and the main region is offset from the inner region by a second distance along the axis.

7. The assembly of claim 6, wherein the first distance provides a space through which the electrical leads can pass.

8. The assembly of claim 7, further comprising a cover plate positioned on the outer rim so that an enclosed space is defined in the support bracket.

9. The assembly of claim 8, wherein the cover is between the surface and the support bracket or the bracket is between the surface and the cover.

10. The assembly of claim 1, wherein the first apertures have a center-to-center distance equal to a center-to-center distance (D) of the pair of structural supports.

11. The assembly of claim 1, wherein the support bracket is configured such that the outer rim extends into the main area to define ears on opposite sides of a portion of the outer rim having the at least one first apertures.

12. The assembly of claim 1, wherein the support bracket is formed as a single piece of galvanized steel.

13. The assembly of claim 1, further comprising a decorative cover, wherein the decorative cover is sized to conceal the support bracket and has second window sized and positioned to be in alignment with the inner region of the support bracket when the cover is removably connected to the support bracket.

14. The assembly of claim 13, wherein the decorative cover comprises an integrally formed connector that is removably connectable with the support bracket.

15. An electrical device support assembly for securement to a surface, comprising:
a support bracket having an outer rim, a main region, and an inner region, the outer rim surrounding the main region, and the main region surrounding the inner region;
at least two first apertures in the main region that are configured to secure the support bracket to a pair of structural supports of the surface, the at least two first apertures having a center-to-center distance equal to a center-to-center distance (D) of the pair of structural supports;
a first distance offsetting the outer rim from the main region in a first direction;
at least two second apertures in the main region that are configured for mechanical connection of an electrical device to the support bracket;
a ground terminal in the main region that is configured for grounding connection of the electrical device;
a cover plate on the outer rim so that an enclosed space is defined in the support bracket, the enclosed space being defined by the first distance between the main region of the bracket, which is against the surface, and the cover; and
a plurality of knockouts in the main region through which electrical leads of an electrical device can pass.

16. The assembly of claim 15, wherein the support bracket is formed as a single piece of galvanized steel.

17. The assembly of claim 15, further comprising a second distance offsetting the inner region from the main region in the first direction.

18. The assembly of claim 17, wherein the main region is configured as an x-shaped structure with the ground terminal and the at least two second apertures on alternating legs of the x-shaped structure.

19. The assembly of claim 15, further comprising a decorative cover, wherein the decorative cover is sized to conceal the support bracket and has second window sized and positioned to be in alignment with the inner region of the support bracket when the cover is removably connected to the support bracket.

20. The assembly of claim 19, wherein the decorative cover comprises an integrally formed lip that is removably connectable with the outer rim of the support bracket.
